(19) United States
(12) Patent Application Publication
(10) Pub. No.: US 2011/0073203 A1
(43) Pub. Date: Mar. 31, 2011

(54) FLOW CHANNEL SWITCHING DEVICE

(76) Inventors: Fumihide NAGASHIMA, Yokohama-shi (JP); Ryoichi Takahashi, Yokosuka-shi (JP); Koichi Matsui, Tokyo (JP)

(21) Appl. No.: 12/868,492

(22) Filed: Aug. 25, 2010

(30) Foreign Application Priority Data
Sep. 30, 2009 (JP) 2009-228638

(51) Int. Cl. F16L 37/34

(52) U.S. Cl. 137/614.03

(57) ABSTRACT

A five-port switch valve includes a cylinder having five chambers defined by four partitions, and two actuators. The valve body of one actuator alternately opens and closes a hole formed in the partition and a hole formed in the partition. The valve body of the other actuator alternately opens and closes a hole formed in the partition and a hole formed in the partition. By virtue of this structure, brine fed into the central chamber through a port is alternately fed into two pressure converters through ports.

### CROSS-REFERENCE TO RELATED APPLICATIONS

This application is based upon and claims the benefit of priority from prior Japanese Patent Application No. 2009-228638, filed Sep. 30, 2009, the entire contents of which are incorporated herein by reference.

### FIELD

An embodiment described herein relates generally to a flow channel switching device for switching flow channels for water or oil etc.

### BACKGROUND

Jpn. Pat. Appln. KOKAI Publication No. 9-52025 (hereinafter referred to as “Patent Document 1”), for example, discloses a reverse osmotic concentration apparatus that incorporates a switch valve as a flow channel switching device for switching flow channels for a high-pressure fluid. The reverse osmotic concentration apparatus is used as, for example, an apparatus for permitting seawater to pass through a reverse osmotic film and thereby be desalted.

The switch valve disclosed in Patent Document 1 is switched by a to-be-concentrated liquid pressurized by a double-acting pump. The to-be-concentrated liquid is, for example, seawater. The pressurized to-be-concentrated liquid is sent to a reverse osmotic film tank through the switched valve. At this time, an impermeant liquid of a relatively high pressure, which does not pass through the reverse osmotic film, is returned to the head-side cylinder chamber of the double-acting pump via the switch valve, where it is used as pressurizing energy for the to-be-concentrated liquid.

When the piston of the double-acting pump reaches the terminal wall of the cap-side cylinder chamber, then, the pump performs backward operation to retract the piston. As a result, a new to-be-concentrated liquid is fed from a to-be-concentrated liquid containing tank to the cap-side cylinder chamber, and the impermeant liquid used for pressurization is discharged from the head-side cylinder chamber via the switch valve.

The switch valve has a spool that is slidable along the inner peripheral wall of the valve chamber. The peripheral surface of the spool functions as a valve body for blocking flow channels when the spool is moving. Further, a circumferential groove for permitting the flow channels to communicate with each other is formed in the periphery of the spool. Namely, the spool of the switch valve is moved in accordance with changes in the pressure of a to-be-concentrated liquid pressurized by the double-acting pump, thereby opening and closing the channel of the to-be-concentrated liquid.

However, in the switch valve disclosed in Patent Document 1, since the flow channels are opened and closed by sliding the spool along the inner peripheral wall of the valve chamber, it is difficult to completely close the flow channels if a fluid of an extremely high pressure is handled as in a seawater desalting plant. Namely, if this switch valve is used in the seawater desalting plant, leakage of seawater may well occur. To avoid this, in the switch valve of Patent Document 1, an O-ring is provided on the periphery of the spool for preventing the leakage of seawater.

Further, in the switch valve of Patent Document 1, supply and discharge of the to-be-concentrated liquid are performed when the spool is reciprocated once, with the result that the liquid is intermittently fed to the reverse osmotic film tank. This reduces the operation rate of the device. To compensate for this disadvantage, if a pair of devices is connected to a single reverse osmotic film tank and is operated alternately, the entire system will be enlarged and its equipment cost will inevitably increase.

In addition, in the switch valve of Patent Document 1, since a plurality of flow channels are simultaneously opened and closed by moving the spool, the flow channels cannot be opened or closed at different times. Accordingly, the switching time of each flow channel cannot be finely adjusted in accordance with, for example, the pressure difference between the flows of the to-be-contracted liquid in the channels. Therefore, the flow channels cannot be smoothly switched.

### BRIEF SUMMARY

It is an object of the invention to provide a flow channel switching device capable of smoothly switching flow channels for high-pressure fluid.

To attain the object, a flow channel switching device according to an embodiment comprises: an inlet port through which a high-pressure fluid is introduced; a high-pressure chamber which receives the high-pressure fluid introduced through the inlet port; a first hole and a second hole formed in walls of the high-pressure chamber; a first feed port which feeds the high-pressure fluid discharged from the high-pressure chamber through the first hole; a second feed port which feeds the high-pressure fluid discharged from the high-pressure chamber through the second hole; a first valve body and a second valve body which independently open and close the first and second holes, respectively; and a first actuator and a second actuator which independently drive the first and second valve bodies, respectively, and alternately feed the high-pressure fluid through the first and second feed holes, respectively.

Since in the embodiment, the first and second actuators are controlled to independently operate so as to alternately open and close the first and second holes of the high-pressure chamber using the first and second valve bodies, pressure loss of the high-pressure fluid and water hammer phenomenon can be prevented. As a result, flow channels for the high-pressure fluid can be switched smoothly.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

FIG. 1 is a schematic block diagram illustrating a seawater desalting plant according to an embodiment;

FIG. 2 is a schematic block diagram illustrating the internal structure of a power recovery device incorporated in the seawater desalting plant of FIG. 1;

FIG. 3 is a sectional view illustrating a five-port switch valve incorporated in the power recovery device of FIG. 2;

FIG. 4 is a sectional view illustrating a state into which the state of the five-port switch valve shown in FIG. 3 is switched; and

FIG. 5 is a schematic block diagram useful in explaining the operation of the power recovery device performed when the five-port switch valve is switched to the state shown in FIG. 4.

### DETAILED DESCRIPTION

An embodiment will be described in detail with reference to the accompanying drawings.

A five-port switch valve 70 according to the embodiment comprises a port 70c through which a high-pressure fluid is introduced, a chamber 71c which receives the fluid introduced through the port 70c, holes 75b and 75c formed in walls of the chamber 71c, a port 70b through which the high-pressure fluid flowing from the chamber 71c into the adjacent chamber 71c via the hole 75b is fed, a port 70d through which the high-pressure fluid flowing from the chamber 71c into the adjacent chamber 71d via the hole 75c is fed, two valve bodies 76 which independently open and close the two holes 75b and 75c, and two actuators 72 and 73 which alternately feed the high-pressure fluid via the ports 70b and 70d.

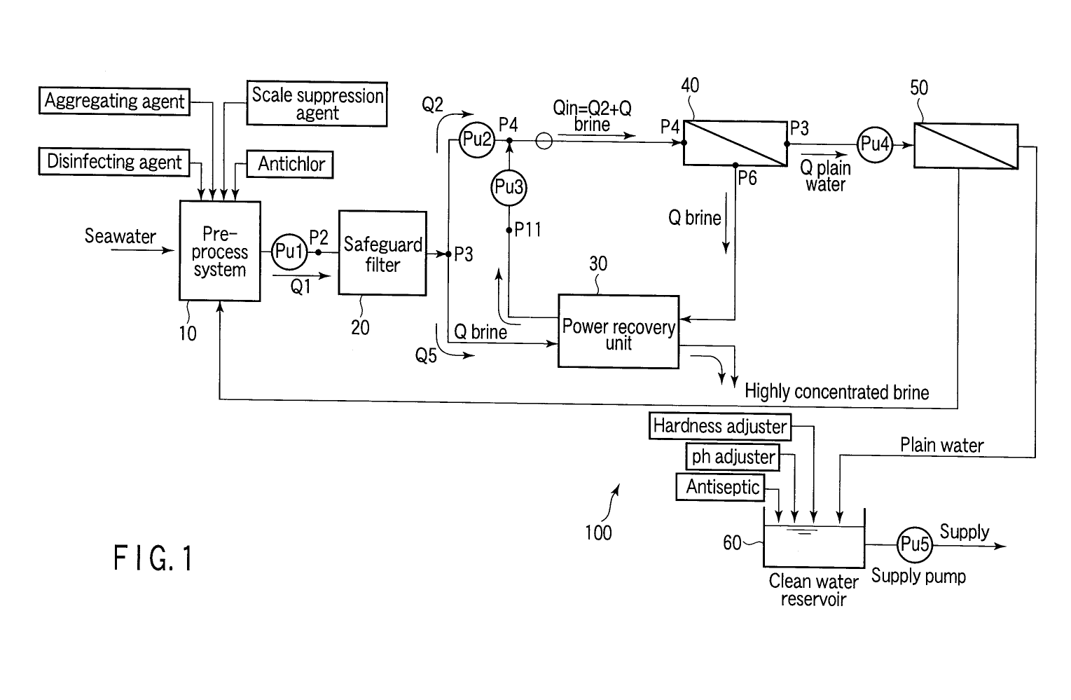

FIG. 1 is a schematic block diagram illustrating a seawater desalting plant 100 for converting seawater into plain water. As shown, in the seawater desalting plant 100, the drawn seawater is subjected to a chemical treatment in a pre-process system 10, and then fed to a safeguard filter 20 by a feed pump Pu1 (Q1). Part of the seawater passing through the safeguard filter 20 is fed to a high-pressure pump Pu2 (Q2), while the other part of the seawater is fed to a power recovery unit 30 (Q5). Assume here that pressure P3 of the seawater fed from the safeguard filter 20 is about 0.2 MPa.

The high-pressure pump Pu2 boosts the pressure of the seawater fed from the safeguard filter 20, and feeds the same to a high-pressure reverse osmotic (RO) film 40. Pressure P4 of the seawater boosted by the high-pressure RO film 40 is set to an appropriate value. The appropriate value depends upon the type of the high-pressure RO film 40. In this embodiment, pressure P4 is set to 6.0 MPa.

The high-pressure RO film 40 filters the seawater boosted and fed by the high-pressure pump Pu2. If the recovery rate of the high-pressure RO film 40 is 40%, the high-pressure RO film 40 produces 40% by volume of plain water and 60% by volume of highly concentrated brine. At this time, the pressure of the plain water passing through the high-pressure RO film 40 decreases to about 0.2 MPa (=P3), while pressure P6 of the highly concentrated brine is about 5.8 MPa.

The plain water filtered and discharged by the high-pressure RO film 40 is fed to a low-pressure pump Pu4 (Q plain water), and the highly concentrated brine that did not pass through the high-pressure RO film 40 is fed to the power recovery unit 30 with its pressure unchanged (Q brine).

The low-pressure pump Pu4 re-pressurizes the plain water discharged from the high-pressure RO film 40, and feeds the resultant water to a low-pressure RO film 50. The plain water filtered by the low-pressure RO film 50 and having, for example, contained boron eliminated is fed to a clean water reservoir 60. The plain water fed to the clean water reservoir 60 is subjected to a chemical treatment, and then supplied as clean water to users via a supply pump Pu5.

On the other hand, substantially plain water, which passed through the high-pressure RO film 40 but did not pass through the low-pressure RO film 50, is returned to the pre-process system 10 and re-fed to the seawater desalting plant 100.

The power recover unit 30 utilizes the pressure of the brine, fed from the high-pressure RO film 40, to further boost the pressure of the seawater fed via the safeguard filter 20, as will be described later. The seawater boosted by the power recover unit 30 is fed to a boosting pump Pu3 (Q brine), where it is further boosted to a desired pressure (=P4).

The seawater adjusted to the desired pressure by and fed from the boosting pump Pu3 is fed to the high-pressure RO film 40 (Qin), together with the seawater (Q2) boosted by the high-pressure pump Pu2.

On the other hand, the brine obtained after being fed to the power recovery unit 30 and utilized to boost the pressure of the seawater is discharged from the power recovery unit 30 with its pressure reduced to substantially the atmospheric pressure.

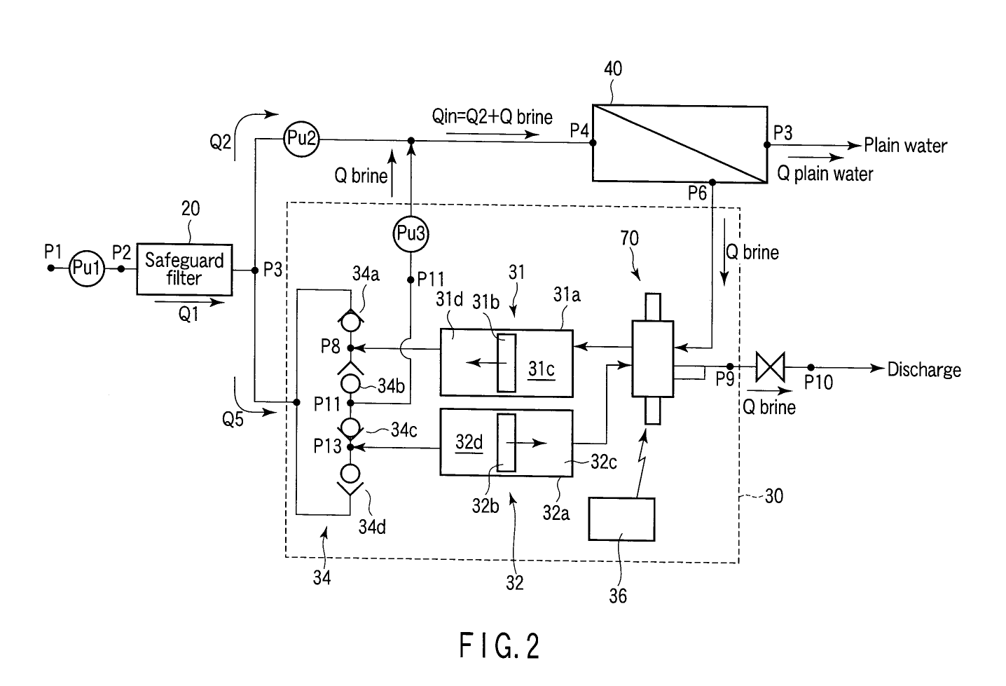

FIG. 2 schematically shows the internal structure of the power recovery unit 30.

As shown, the power recovery unit 30 comprises a five-port switch valve 70, pressure converters 31 and 32, a seawater supply unit 34, and a controller 36. The five-port switch valve 70 functions as the fluid switching unit of the invention. The controller 36 monitors the operation states of the two pressure converters 31 and 32 to thereby control the switching of the five-port switch valve 70.

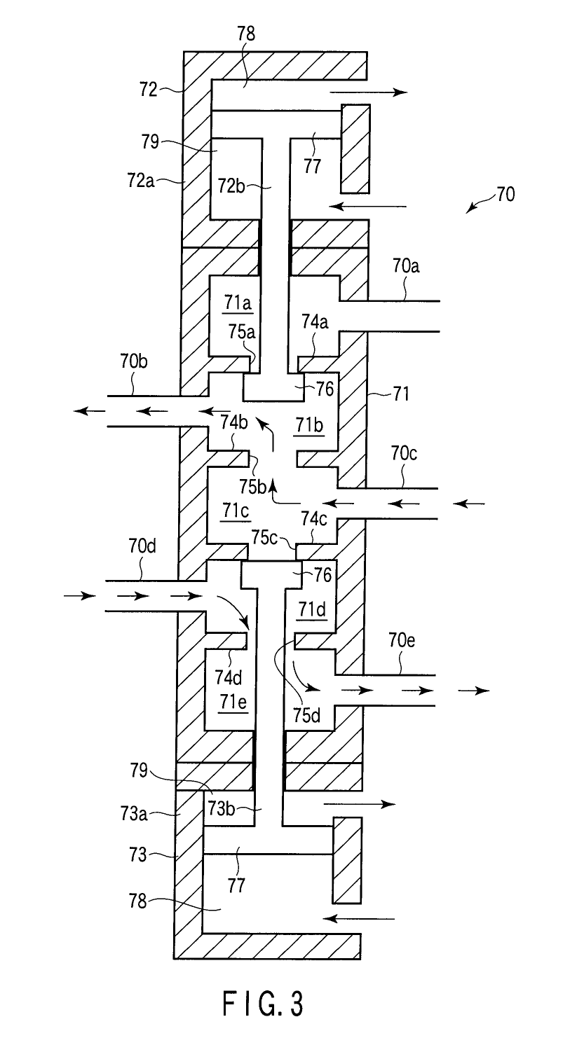

As shown in FIG. 3, the five-port switch valve 70 comprises a cylinder with five ports 70a, 70b, 70c, 70d and 70e formed through the peripheral wall of the valve, and two actuators 72 and 73 secured to the opposite ends of the cylinder 71.

The upper actuator 72 functions as a first actuator, while the lower actuator 73 functions as a second actuator. The invention is not limited to use the actuators 72 and 73, but may use other driving mechanisms.

The five ports 70a, 70b, 70c, 70d and 70e may be formed in portions other than those shown in FIG. 3. The central portion 70c functions as an inlet port, the port 70b functions as a first feed port, and the port 70d functions as a second feed port.

The cylinder 71 has five cylindrical chambers 71a, 71b, 71c, 71d and 71e, which communicate with the five ports 70a, 70b, 70c, 70d and 70e. Four disk-shaped partitions 74a, 74b, 74c and 74d are provided between respective pairs of adjacent chambers.

The central chamber 71c functions as a high-pressure chamber, and the chambers 71b and 71d adjacent to the central chamber 71c function as first and second chambers, and the opposite end chambers 71a and 71e function as third and fourth chambers.

Circular holes 75b and 75c to be opened and closed by respective valve bodies 76, described later, are formed in the central portions of the central partitions 74b and 74c, respectively. Similarly, circular holes 75a and 75d that are opened and closed by the respective valve bodies 76, and insert therein piston rods 72b and 73b, respectively, are formed in the central portions of the two outer partitions 74a and 74d, respectively.

The hole 75b of the partition 74b functions as a first hole, the hole 75c of the partition 74c functions as a second hole, the hole 75a of the partition 74a functions as a third hole, and the hole 75d of the partition 74d functions as a fourth hole.

The actuator 72 comprises a piston cylinder 72a secured to an end wall of the cylinder 71, and a piston rod 72b inserted through the hole 75a of the partition 74a. Similarly, the actuator 73 comprises a piston cylinder 73a secured to the other end wall of the cylinder 71, and a piston rod 73b inserted through the hole 75d of the partition 74d. A valve body 76 is provided as the distal end of the piston rod 72b for closing the holes 75a and 75b of the two partitions 74a and 74b. Similarly, another valve body 76 is provided as the distal end of the piston rod 73b for closing the holes 75c and 75d of the two partitions 74c and 74d.

The valve body 76 of the actuator 72 functions as a first valve body, and is positioned in the chamber 71b. The valve body 76 of the actuator 73 functions as a second valve body, and is positioned in the chamber 71d. Further, the respective pistons 77 movable within the piston cylinders 72a and 73a are provided as the proximal ends of the piston rods 72b and 73b.

The actuators 72 and 73 are connected to respective pumps (not shown). Namely, air is alternately supplied into two pressure chambers 78 and 79 defined in the piston cylinders 72a and 73a, respectively, thereby operating the pistons 77 to axially move the valve bodies 76 as the distal ends of the piston rods 72b and 73b. Not only air pressure but also hydraulic pressure may be used to drive the actuators 72 and 73.

When the actuator 72 is driven, the hole 75a formed in the partition 74a between the chambers 71a and 71b of the cylinder 71, and the hole 75b formed in the partition 74b between the chambers 71b and 71c of the cylinder 71 are alternately opened and closed by the corresponding valve body 76. Further, when the other the actuator 73 is driven, the hole 75c formed in the partition 74c between the chambers 71c and 71d of the cylinder 71, and the hole 75d formed in the partition 74d between the chambers 71c and 71d of the cylinder 71 are alternately opened and closed by the corresponding valve body 76.

In the embodiment, the two valve bodies 76 are independently openable and closable. The valve bodies 76 function as grove valves that axially move with respect to the holes 75a, 75b, 75c and 75d of the partitions 74a, 74b, 74c and 74d to open and close the holes. This valve structure is suitable for the seawater desalting plant 100 that handles high-pressure fluid.

Brine is introduced from the high-pressure RO film 40 into the port 70c communicating with the central chamber 71c of the cylinder 71. Further, the brine introduced into the central chamber 71c through the port 70c is alternately fed into the pressure converters 31 and 32 through the ports 70b and 70d communicating with the two chambers 71b and 71d adjacent to the central chamber 71c. The ports 70a and 70e communicating with the opposite end chambers 71b and 71d are joined together downstream of the switch valve 70, and are used to discharge the respective flows of brine fed from the pressure converters 31 and 32 with their pressures reduced.

Returning to FIG. 2, the pressure converters 31 and 32 comprise cylinders 31a and 32a, and pistons 31b and 32b for defining axial chambers in the cylinders 31a and 32a, respectively. The piston 31b axially moves to offset the pressure difference between the two pressure chambers 31c and 31d defined on the opposite sides of the piston 31b. Similarly, the piston 32b axially moves to offset the pressure difference between the two pressure chambers 32c and 32d defined on the opposite sides of the piston 32b. The pressure chambers 31c and 32c are connected to the ports 70b and 70d of the five-port switch valve 70, respectively. The other pressure chambers 31d and 32d are connected to a seawater feed unit 34, described later. Namely, brine is fed into the pressure chambers 31c and 32c, while seawater is fed into the other pressure chambers 31d and 32d. In other words, the seawater and brine are prevented from mixing in the pressure converters 31 and 32.

The seawater feed unit 34 comprises four check valves 34a, 34b, 34c and 34d connected in series. The check valves 34a, 34b, 34c and 34d open and close independently of each other in accordance with the pressure difference between the opposite ends of each valve. Namely, the four check valves 34a, 34b, 34c and 34d feed the seawater from the safeguard filter 20 into the pressure chambers 31d and 32d of the pressure converters 31 and 32, and feed the seawater from the pressure chambers 31d and 32d into the above-mentioned boosting pump Pu3.

The controller 36 monitors the operation of the two pressure converters 31 and 32 and independently controls the two actuators 72 and 73 of the five-port switch valve 70.

Referring now to FIGS. 2 to 5, a description will be given of the operation of the power recovery unit 30 constructed as the above, and the operation of the five-port switch valve 70.

As indicated by the arrows in FIG. 3, the brine fed from the high-pressure RO film 40 at relative high pressure P6 (=5.8 MPa) flows into the central chamber 71c via the central port 70c of the five-port switch valve 70. At this time, if the controller 36 switches the two actuators 72 and 73 to the state shown in FIG. 3, the brine in the chamber 71c flows into the adjacent chamber 71b through the hole 75b of the partition 74b, and then into the pressure chamber 31c of the pressure converter 31 via the port 70b.

The state in which the controller 36 moves the two valve bodies 76 to the positions shown in FIG. 3 will be hereinafter referred to as “the first state.” In the first state, the controller 36 sets the actuator 72 so that the corresponding valve body 76 blocks the hole 75a of the partition 74a, and sets the other actuator 73 so that the corresponding valve body 76 blocks the hole 75c of the partition 74c.

The brine flowing into the pressure chamber 31c of the pressure converter 31 pushes, by the pressure difference between the pressure chambers 31c and 31d, the piston 31b in the direction indicated by the arrow in FIG. 2 to thereby push the seawater filled in the pressure chamber 31d into the seawater supply unit 34.

At this time, pressure P8 of the seawater pushed out of the pressure chamber 31d is slightly reduced to about 5.75 MPa by the friction of the piston 31b.

Pressure P3 of the seawater fed from the safeguard filter 20 into the seawater supply unit 34 is about 0.2 MPa as mentioned above. Accordingly, when the five-port switch valve 70 is in the first state, the check valve 34a is closed by the difference between the pressures P3 and P8.

Further, at this time, since pressure P11 between the check valves 34b and 34c is maintained at substantially the same pressure as pressure P8 as described later, the check valve 34b is opened. Furthermore, since pressure P13 between the check valves 34c and 34d is close to the atmospheric pressure as described later, the check valve 34c is closed by the difference between pressures P11 and P13.

As a result, the brine pushed out of the pressure chamber 31d by a pressure of about 5.75 MPa is fed to the boosting pump Pu3 through the check valve 34b. The boosting pump Pu3 slightly boosts the pressure of the brine from the pressure chamber 31d (5.75 MPa→6.0 MPa) and feeds the resultant brine to the high-pressure RO film 40. Namely, the power recovery unit 30 converts, using the pressure converter 31, the energy of the brine discharged from the high-pressure RO film 40 into the energy for boosting seawater.

Referring back to FIG. 3, in the above-mentioned first state, the valve body 76 of the other actuator 73 blocks the hold 75c of the partition 74c. In other words, in the first state, the hole 75d of the partition 75d is open to thereby connect the chambers 71d and 71e. As described above, in the first state, the chamber 71e is set at substantially the same pressure as the atmospheric pressure via the port 70e, and hence the chamber 71d is also set at substantially the same pressure as the atmospheric pressure. Further, the pressure chamber 32c of the pressure converter 32, which communicates with the chamber 71d via the port 70d, is open to the atmosphere.

On the other hand, the seawater fed from the safeguard filter 20 to the seawater supply unit 34 under pressure P3 is further fed into the pressure chamber 32d of the pressure converter 32 via the check valve 34d. At this time, the pressure in the pressure chamber 32d becomes slightly higher than that in the pressure chamber 32c, whereby the piston 32b is moved in the direction indicated by the arrow of FIG. 2. As a result, the pressure in the pressure chamber 32d also becomes close to the atmospheric pressure. At the same time, the brine filled in the pressure chamber 32c is pushed by the piston 32b to the five-port switch valve 70.

At this time, the check valve 34d is opened by the difference between pressure P3 and the pressure in the pressure chamber 32d, thereby permitting the seawater to flow therethrough. The check valves 34a and 34c are closed by the pressure of the brine as mentioned above. Accordingly, the seawater fed from the safeguard filter 20 flows into the pressure chamber 32d through the check valve 34d.

As described above, in the first state in which the two actuators 72 and 73 of the five-port switch valve 70 assume the positions shown in FIG. 3, the controller 36 monitors the positions of the pistons 31b and 32b of the pressure converters 31 and 32, and independently controls the switching of the actuators 72 and 73 when each of the pistons 31b and 32b reaches an end.

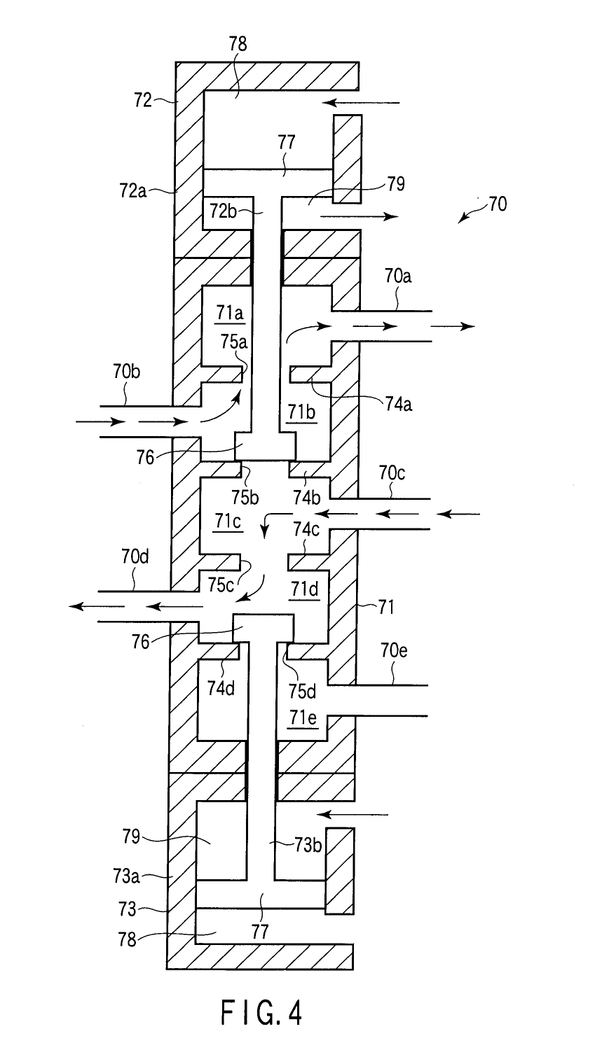

Basically, when the piston 31b of the pressure converter 31 is pressed by the brine and the volume of the chamber 31d becomes substantially zero, the controller 36 switches the actuator 72 to the position shown in FIG. 4. As a result, the hole 75a of the partition 74a is opened, the hole 75b of the partition 74b is closed by the valve body 76, thereby connecting the chambers 71a and 71b.

Similarly, when the piston 32b of the other pressure converter 32 is pressed by the seawater and the volume of the chamber 32d becomes substantially zero, the controller 36 switches the actuator 73 to the position shown in FIG. 4. As a result, the hole 75c of the partition 74c is opened, the hole 75d of the partition 74d is closed by the valve body 76, thereby connecting the chambers 71c and 71d. The state in which the actuators 72 and 73 are set at the positions shown in FIG. 4 will be hereinafter referred to as “the second state.”

However, since the five-port switch valve 70 of the embodiment can independently control the operations of the two actuators 72 and 73, it is not always necessary to simultaneously switch the positions of the actuators 72 and 73. Further, since there is a difference between the pressures applied to the pistons 31b and 32b of the two pressure converters 31 and 32, the two pistons 31b and 32b may reach their respective ends at different times even if the positions of the two actuators 72 and 73 are simultaneously switched.

For instance, if the two actuators 72 and 73 are completely simultaneously switched from the positions shown in FIG. 3 to those shown in FIG. 4, a state, in which the two valve bodies 76 block none of the check valves 75a, 75b, 75c and 75d, will occur for a slight period immediately after the two valve bodies 76 start to move. In this case, the pressure in the central chamber 71c is reduced, which is regarded as a pressure loss.

To avoid such a disadvantage as the above, a method could be employed, in which, firstly, only the actuator 72 is switched from the position shown in FIG. 3 to thereby block the hold 75b of the one partition 74b defining the central chamber 71c, and then the other actuator 73 is switched to block the hold 75c of the other partition 74c defining the central chamber 71c.

However, if the state, in which the corresponding valve body 76 blocks the hole 75b of the partition 74b and the other valve body 76 blocks the hole 75c of the partition 74c, is prolonged, the pressure in the thus-sealed central chamber 71c increases, whereby a water hammer phenomenon may well occur in which when the valve body 76 blocking the hole 75c is opened as shown in FIG. 4, the brine pressurized in the chamber 71c will rapidly flow.

Furthermore, in the first state shown in FIG. 3, since the two communicating chambers 71b and 71c are kept under high pressure, it is easy to open the valve body 76 blocking the hole 75c, whereas a relatively high torque is necessary to move the other valve body 76 to open the hole 75a of the partition 74a. Namely, even if the controller 36 switches the two actuators 72 and 73 at desired times, there may occur a light difference between the movements of the two valve bodies 76.

Therefore, in the embodiment, in consideration of the difference between the movements of the two valve bodies 76, the operation times of the two actuators 72 and 73 are set so that almost simultaneously when the corresponding valve body 76 blocks the hole 75b of the partition 74b, the other valve body 76 opens the hole 75c of the partition 74c. This structure can minimize the above-mentioned pressure loss, prevent the water hammer phenomenon, and realize smooth switching of the five-port switch valve 70.

Referring again to FIG. 4, after the controller 36 switches the five-port switch valve 70 to the second state, the high-pressure brine filling the central chamber 71c flows into the chamber 71d through the hole 75c of the partition 74c, and then into the pressure chamber 32c of the other pressure converter 32 through the port 70d.

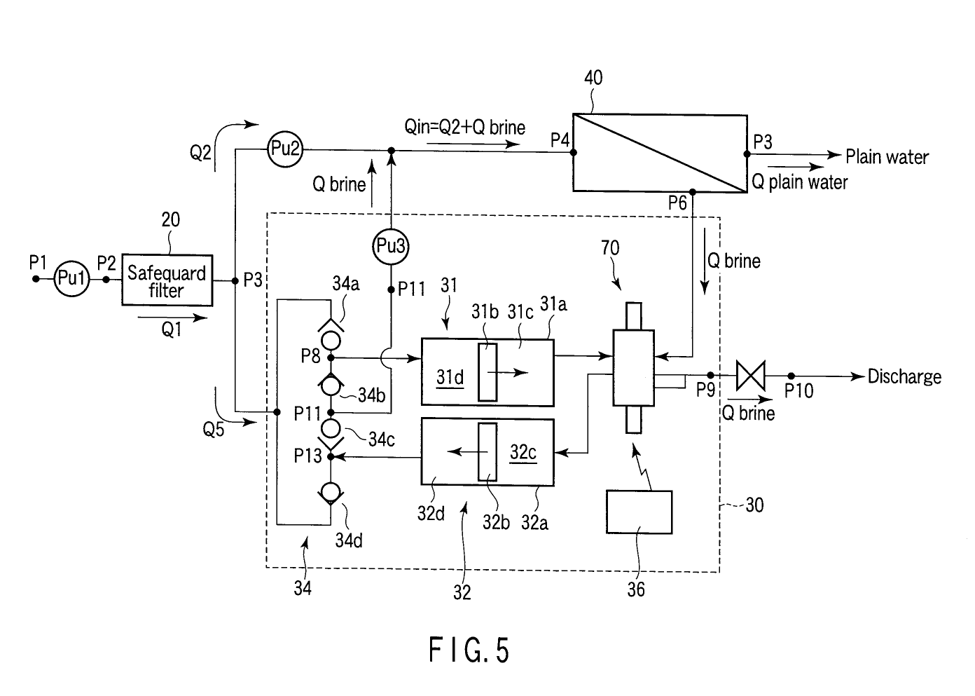

In the state (i.e., the first state) assumed before the controller 36 switches the five-port switch valve 70 to the second state, the two pressure chambers 32c and 32d of the pressure converter 32 are under low pressures substantially equal to the atmospheric pressure. Accordingly, if high-pressure brine flows into the pressure chamber 32c of the pressure converter 32, the piston 32b is pushed in the direction indicated by the arrow in FIG. 5 as a result of the pressure difference between the chambers.

Consequently, the pressure of the seawater filled in the pressure chamber 33d is increased and the thus pressurized seawater is pushed into the seawater supply unit 34. At this time, pressure P13 of the seawater pushed from the pressure chamber 32d is slightly reduced to about 5.75 MPa by the friction of the piston 32b.

On the other hand, pressure P3 of the seawater fed from the safeguard filter 20 to the seawater supply unit 34 is about 0.2 MPa as described previously. Accordingly, in the second state in which the five-port switch valve 70 is switched as shown in FIG. 4, the check valve 34d is closed by the difference between pressure P1 and pressure P13.

Further, at this time, since pressure P11 assumed immediately before switching to the second state is substantially maintained at high, pressures P13 and P11 are substantially the same pressure, and hence the check valve 34c will be opened. Further, since pressure P8 is set to a value substantially equal to the atmospheric pressure as will be described later, the check valve 34b is closed by the difference between pressures P11 and P8.

Thus, the brine pushed from the pressure chamber 32d under about 5.75 MPa is fed into the booster pump Pu3 through the check valve 34c. The booster pump Pu3 slightly boosts the pressure of the brine fed from the pressure chamber 32d (5.75 MPa→6.0 MPa), and feeds the resultant brine to the high-pressure RO film 40. Namely, the power recovery unit 30 converts, using the pressure converter 32, the energy of the brine discharged from the high-pressure RO film 40 into the energy for boosting seawater.

In contrast, in the second state shown in FIG. 4, the valve body 76 of the actuator 72 blocks the hole 75b of the partition 74b and opens the hole 75a of the partition 74a, thereby connecting the two chambers 71a and 71b. Since in this state, the port 70a is open to the atmosphere, the two communicating chambers 71a and 71b are also open to the atmosphere. Similarly, the pressure chamber 31c of the pressure converter 31 is open to the atmosphere through the port 70b.

In the first state assumed before switching the five-port switch valve 70 to the second state, the other pressure chamber 31d of the pressure converter 31 is kept under high pressure. Accordingly, when the controller 36 switches the five-port switch valve 70 to the second state to cause the pressure in the pressure chamber 31d to be substantially equal to the atmospheric pressure, the piston 31b is moved in the direction indicated by the arrow shown in FIG. 5 by the difference between the pressures in the pressure chambers 31c and 31d. As a result, the pressure in the pressure chamber 31d is also reduced to a value close to the atmospheric pressure, and pressure P8 is reduced to a value close to the atmospheric pressure.

Namely, at this time, the check valve 34a is opened by the difference between pressures P3 and P8, whereby the seawater fed from the safeguard filter 20 flows into the pressure chamber 31d of the pressure converter 31 through the check valve 34a.

After that, the controller 36 monitors the positions of the pistons 31b and 32b of the pressure converters 31 and 32, and slightly moves, as mentioned above, the switching of the actuators 72 and 73 when each of the pistons 31b and 32b reaches an end, thereby switching the five-port switch valve 70 to the first state shown in FIG. 3.

As described above, the controller 36 of the power recovery unit 30 repeats the above-mentioned operations to alternately switch the five-port switch valve 70 between the first and second states, thereby re-feeding seawater to the high-pressure RO film 40 using the pressure of the brine fed from the high-pressure RO film 40 for boosting the pressure of the seawater. In the power recovery unit 30 of the embodiment, since the five-port switch valve 70 is operated in the manner as described above, the flow channels for brine having an extremely high pressure that is about 60 times higher than the atmospheric pressure can be smoothly switched without pressure loss and water hammer phenomenon.

In contrast, in the case of driving one actuator having the two valve bodies formed integral as one body, it is necessary to enhance the dimension accuracy of the two valve bodies 76, and the holes 75a, 75b, 75c and 75d of the partitions 74a, 74b, 74c and 74d, which inevitably increases the manufacturing cost of the five-port switch valve 70.

If the dimension accuracy is degraded, clearances will be formed between the valve bodies 76, and the holes 75a, 75b, 75c and 75d, resulting in leakage of brine therethrough, i.e., in pressure loss. In particular, if the two valve bodies 76 are formed integral as one body, a clearance will be formed between one of the valve bodies and a hole, with the other valve body kept in contact with another hole. To avoid this, high accuracy of dimension is required. Further, if the two valve bodies 76 are formed as one body, they cannot be operated independently, with the result that the above-mentioned water hammer phenomenon cannot be avoided.

This being so, in an apparatus that handles an extremely high pressure fluid, like the above-described seawater desalting plant 100, it is advantageous to employ, as in the five-port switch valve 70, actuators 72 and 73 that can independently drive two valve bodies 76 for opening and closing flow channels for a high-pressure fluid.

While a certain embodiment of the invention has been described, the embodiment has been presented by way of example only, and is not intended to limit the scope of the invention. Indeed, the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

For instance, in the above-described embodiment, a description is given of the case where the invention is applied to the five-port switch valve 70 incorporated in the power recovery unit 30 of the seawater desalting plant 100. However, the invention may be also applied to a valve for switching flow channels for another high-pressure fluid such as oil.

In addition, a method utilizing air pressure, water pressure, oil pressure or a solenoid coil is possible as a method of switching the positions of the actuators 72 and 73 of the five-port switch valve 70. In particular, brine, seawater fed from the feed pump Pu1, or brine fed from the high-pressure pump Pu2, may be used as a hydraulic source used as a power source for switching the positions of the actuators 72 and 73.

1. A flow channel switching device comprising:
an inlet port through which a high-pressure fluid is introduced;
a high-pressure chamber which receives the high-pressure fluid introduced through the inlet port;
a first hole and a second hole formed in wall of the high-pressure chamber;
a first feed port which feeds the high-pressure fluid discharged from the high-pressure chamber through the first hole;
a second feed port which feeds the high-pressure fluid discharged from the high-pressure chamber through the second hole;
a first valve body and a second valve body which independently open and close the first and second holes, respectively; and
a first actuator and a second actuator which independently drive the first and second valve bodies, respectively, and alternately feed the high-pressure fluid through the first and second feed ports, respectively.

2. The flow channel switching device according to claim 1, further comprising:
a first chamber communicating with the high-pressure chamber through the first hole; and
a second chamber communicating with the high-pressure chamber through the second hole,
wherein
the first valve body is movable in the first chamber, and the first feed port communicates with the first chamber; and
the second valve body is movable in the second chamber, and the second feed port communicates with the second chamber.

3. The flow channel switching device according to claim 2, further comprising:
a third hole formed in a wall of the first chamber coaxially with the first hole;
a third chamber communicating with the first chamber through the third hole;
a fourth hole formed in a wall of the second chamber coaxially with the second hole; and
a fourth chamber communicating with the second chamber through the fourth hole,
wherein
the first actuator is reciprocated between a position at which the first valve body closes the first hole, and a position at which the first valve body closes the third hole, to thereby alternately open and close the first and third holes; and
the second actuator is reciprocated between a position at which the second valve body closes the second hole, and a position at which the second valve body closes the fourth hole, to thereby alternately open and close the second and fourth holes.
